(19) United States
(12) Patent Application Publication
(10) Pub. No.: US 2013/0238426 A1
(43) Pub. Date: Sep. 12, 2013

(54) PROVIDING ADVERTISEMENTS VIA MULTIPLE DEVICES

(71) Applicants: Aveek MUKHOPADHYAY, New Delhi (IN); Suyash Kumar SINGH, Uttar Pradesh (IN); Jubish Cheriya PARAMBATH, Chennai (IN); Anand SANKARAN, Chennai (IN); Muhammed SHAPHY, Irving, TX (US)

(72) Inventors: Aveek MUKHOPADHYAY, New Delhi (IN); Suyash Kumar SINGH, Uttar Pradesh (IN); Jubish Cheriya PARAMBATH, Chennai (IN); Anand SANKARAN, Chennai (IN); Muhammed SHAPHY, Irving, TX (US)

(73) Assignee: VERIZON PATENT AND LICENSING INC., Basking Ridge, NJ (US)

(21) Appl. No.: 13/413,226

(22) Filed: Mar. 6, 2012

(51) Int. Cl. G06Q 30/02

(52) U.S. Cl. 705/14.49

(57) ABSTRACT

A device transmits a first advertisement to a client device of a user; updates an indicator, associated with the user, to indicate that the device transmitted the first advertisement to the client device; and receives a request from a user device of the user. The request includes an identifier associated with the user. The device further determines, based on the identifier, that the user of the user device is also the user of the client device; determines, based on the identifier and the indicator, that the device transmitted the first advertisement to the client device; selects a second advertisement for the user device based on the request; and transmits the second advertisement to the user device. The first advertisement and the second advertisement advertise a particular item.

### BACKGROUND

Television viewers increasingly utilize a variety of technologies (e.g., Video on Demand (VOD), a digital video recorder (DVR), etc.) that allow them to enjoy programs without viewing advertisements that are traditionally displayed between portions of the programs. Consequently, content service providers (e.g., cable companies) are increasingly showing advertisements before the television viewers begin viewing the programs. However, the television viewers have the ability to dismiss (i.e., cancel) the advertisements before having an opportunity to consider and/or take advantage of promotions that are being offered via the advertisements. Additionally, television viewers are increasingly multi-tasking, by using other devices (e.g., a mobile telephone device) while watching television. Thus, the television viewers may miss or ignore advertisements that are displayed on television screens because they are looking at screens of the other devices while the advertisements are displayed.

As a result, content service providers are losing opportunities to show advertisements to television viewers. Furthermore, showing the advertisements only on television screens limits the types of advertisements that can be shown to the television viewers and/or the ease with which the television viewers can take advantage of promotions that are being offered via the advertisements.

### BRIEF DESCRIPTION OF THE DRAWINGS

FIGS. 1A and 1B are diagrams that illustrate an overview of an implementation described herein;

FIG. 2 is a diagram of an example environment in which systems and/or methods described herein may be implemented;

FIG. 3 is a diagram of example devices associated with a video provisioning system of FIG. 2;

FIG. 4 is a diagram of example components that correspond to one or more of the devices of FIGS. 2 and/or 3;

FIGS. 5-7 are flow charts of an example process for providing advertisements via multiple devices; and

FIGS. 8A-8F are diagrams of example advertisement information that may be provided to multiple devices.

### DETAILED DESCRIPTION OF PREFERRED EMBODIMENTS

The following detailed description refers to the accompanying drawings. The same reference numbers in different drawings may identify the same or similar elements.

An implementation described herein may provide advertisements to multiple devices via screens or displays associated with the devices. For example, an advertisement server may transmit a first advertisement to a client device (e.g., a set-top box (STB)) of a user. The client device may display the first advertisement on a display screen, such as a television. Thereafter, the advertisement server may receive a request for information from a user device, such as a mobile telephone device, of the user. In response to the request, the advertisement server may select a second advertisement for the user device. The second advertisement may advertise, for example, the same item (e.g., movie) as the first advertisement. The advertisement server may transmit the second advertisement to the user device, and the user device may display the second advertisement on a screen of the user device.

As a result, the user may view the second advertisement on the screen of the user device even if the user dismisses the first advertisement or ignores the display screen while the first advertisement is displayed. Furthermore, the second advertisement may provide additional information about a promotion being offered via the first advertisement. In addition, the user may use the user device to immediately take advantage of the promotion (e.g., purchase the item) being offered via the first advertisement and/or the second advertisement.

As used herein, the terms user, viewer, subscriber, and/or customer may refer interchangeably to a client device and/or a user device, or a user of a client device and/or a user device.

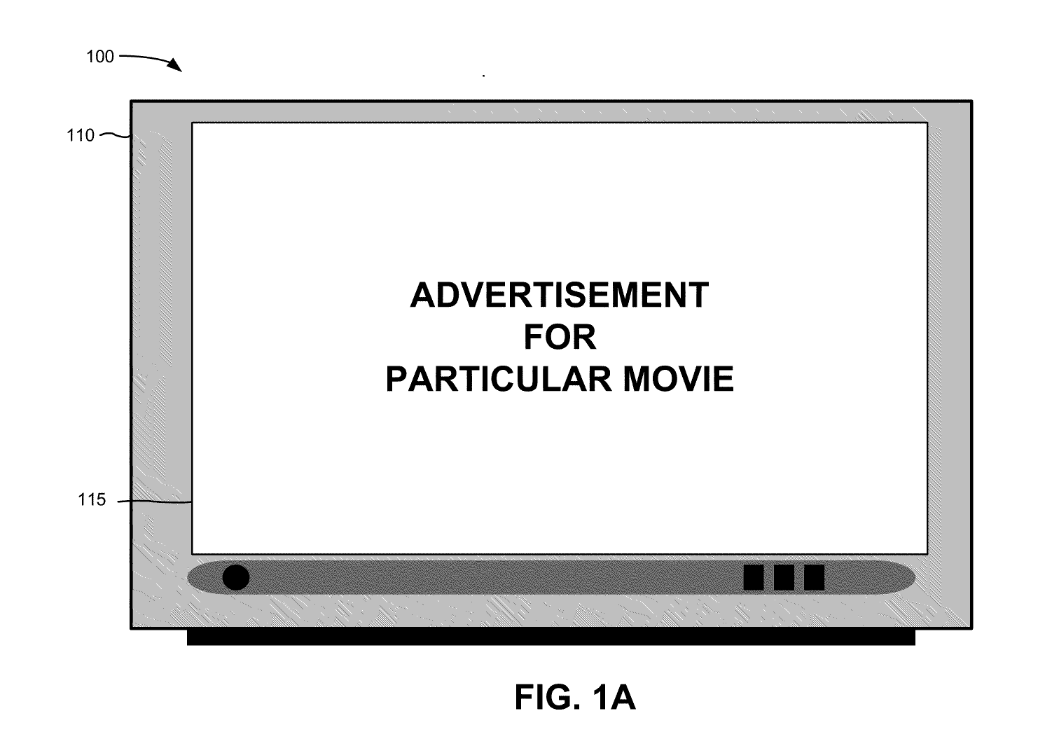

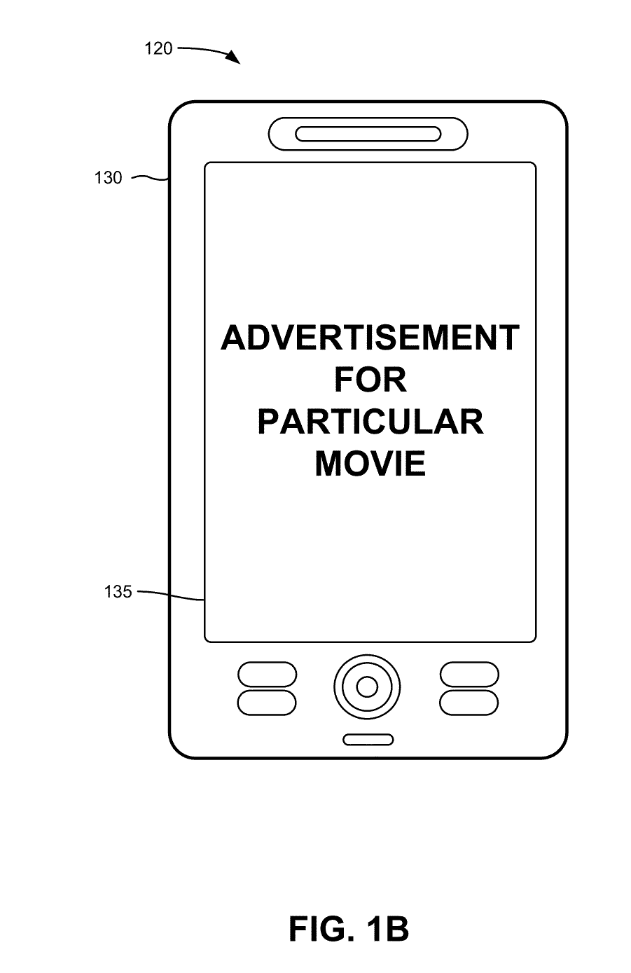

FIGS. 1A and 1B are diagrams that illustrate an overview of an implementation described herein. FIG. 1A is a diagram 100 of a television screen 110 that is displaying an advertisement 115. FIG. 1B is a diagram 120 of a mobile device 130 that is displaying an advertisement 135.

In this example, assume that a user operates a client device (e.g., a STB), associated with television screen 110, and also operates mobile device 130. Further assume that the user uses the client device to select particular content to view on television screen 110. In response to the selection, the client device may transmit a request to an advertisement server that provides advertisements. The request may indicate that the client device may display an advertisement, on television screen 110, before playing the particular content. In response to the request, the advertisement server may select advertisement 115 that is for a particular movie, and may transmit advertisement 115 to the client device. The client device may display advertisement 115 on television screen 110.

Simultaneously, or after advertisement 115 is displayed on television screen 110, the advertisement server may receive a request for information from mobile device 130. The request may indicate that mobile device 130 is ready to display another advertisement if an advertisement was previously transmitted to the client device that is associated with mobile device 130. In response to the request, the advertisement server may determine that advertisement 115 was transmitted to the client device, and may select advertisement 135, which is also for the particular movie. Additionally, or alternatively, as described further below, advertisement 135 may be for a different movie and/or for any other type of product or service. The advertisement server may transmit advertisement 135 to mobile device 130, and mobile device 130 may display advertisement 135. Accordingly, the user may view advertisements for the particular movie on television screen 110 and/or mobile device 130.

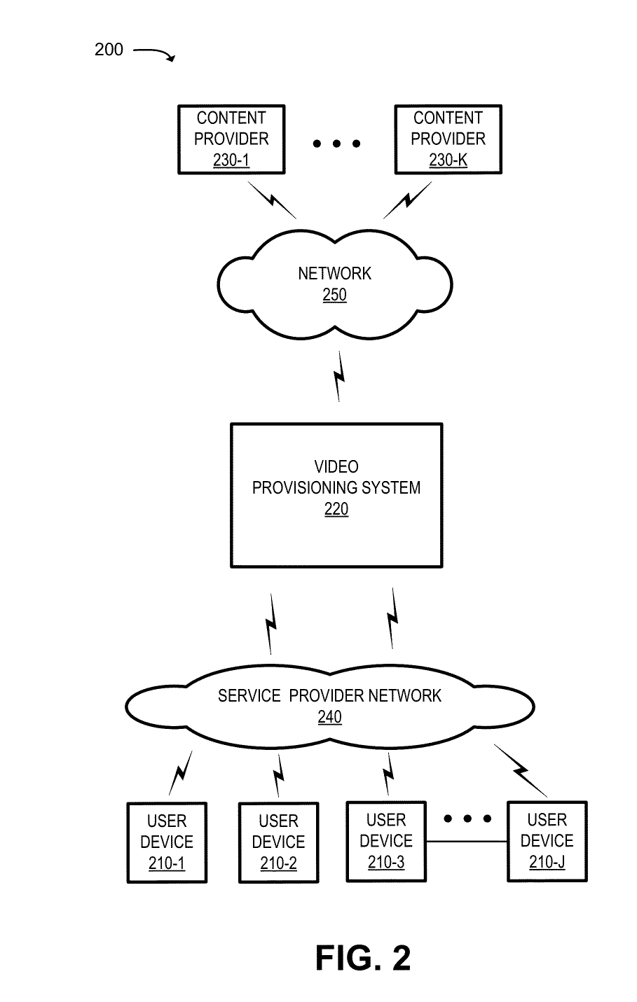

FIG. 2 is a diagram of an example environment 200 in which systems and/or methods, described herein, may be implemented. As shown in FIG. 2, environment 200 may include a group of user devices 210-1, . . . , 210-J (where J≧1) (hereinafter referred to collectively as “user devices 210” and individually as “user device 210”), a video provisioning system (VPS) 220, a group of content providers 230-1, . . . , 230-K (where K≧1) (hereinafter referred to collectively as “content providers 230” and individually as “content provider 230”), a service provider network 240, and a network 250. The number of devices, systems, and/or networks, illustrated in FIG. 2, is provided for explanatory purposes only. In practice, there may be additional devices, systems, and/or networks; fewer devices, systems, and/or networks; different devices, systems, and/or networks; or differently arranged devices, systems, and/or networks than illustrated in FIG. 2.

Also, in some implementations, one or more of the devices of environment 200 may perform one or more functions described as being performed by another one or more of the devices of environment 200. Devices, systems, and/or networks of environment 200 may interconnect via wired connections, wireless connections, or a combination of wired and wireless connections.

User device 210 may include a computation or communication device that is capable of communicating with service provider network 240. For example, user device 210 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a laptop computer, a tablet computer, a set top box, a digital video recorder (DVR), a personal gaming system, a smart phone, or another type of computation or communication device.

User device 210 may host a media manager application (hereinafter referred to as “media application”) that enables user device 210 to communicate with VPS 220 and/or to perform certain operations to obtain video content from VPS 220. For example, the media application may enable user device 210 to access a portal (e.g., a website, a user interface, an IMG, etc.) associated with VPS 220, to browse, search, select, and/or obtain a video asset in exchange for payment (e.g., as a purchase, rental, pay-per-view, subscription, etc.). The media application may manage information associated with DRM with respect to the video asset and may use license information, obtained from VPS 220, to decrypt the video asset for playing on user device 210. The media application may bookmark a location at which user device 210 stopped playing the video asset and may transmit the bookmarked location to VPS 220. Another user device 210, associated with the user, may obtain a copy of the video asset from VPS 220 and may resume playing the video asset based on the bookmarked location obtained from VPS 220.

The media application may permit a particular type of user device 210 (e.g., a wireless mobile handset device associated with user device 210-J) to obtain the video asset from another type of computer device 210 (e.g., a computer device associated with user device 210-3) via a side loading operation (e.g., via a wired and/or wireless connection) instead of, or in addition to, obtaining the video asset from VPS 220.

VPS 220 may include one or more devices that gather, process, search, store, and/or provide information in a manner similar to that described herein. VPS 220 may be capable of communicating with content providers 230 via network 250 and/or user devices 210 via service provider network 240. VPS 220 may perform operations associated with video content ingestion, processing, and distribution for one or more types of user devices 210, associated with a user, within environment 200.

Content provider 230 may include any type or form of content provider. For example, content provider 230 may include free television broadcast providers (e.g., local broadcast providers, such as NBC, CBS, ABC, FOX, etc.), for-pay television broadcast providers (e.g., TNT, ESPN, HBO, CNN, etc.), and/or Internet-based content providers that stream content from web sites and/or permit content to be downloaded (e.g., via progressive download, etc.). Content provider 230 may include on-demand content providers (e.g., VOD, PPV, etc.). A media stream, as used herein, may refer to a stream of content that includes video content (e.g., a video stream), audio content (e.g., an audio stream), and/or textual content (e.g., a textual stream).

Service provider network 240 may include one or more wired and/or wireless networks via which user devices 210 communicate with and/or receive video content from VPS 220. For example, service provider network 240 may include a cellular network, the Public Land Mobile Network (PLMN), a second generation (2G) network, a third generation (3G) network, a fourth generation (4G) network (e.g., a long term evolution (LTE) network), a fifth generation (5G) network, and/or another network. Additionally, or alternatively, service provider network 240 may include a code division multiple access (CDMA) network, a global system for mobile communications (GSM) network, a general packet radio services (GPRS) network, or a combination of CDMA, GSM, and/or GPRS networks. Additionally, or alternatively, service provider network 240 may include a wide area network (WAN), a metropolitan area network (MAN), an ad hoc network, an intranet, a fiber optic-based network (e.g., a fiber optic service (FiOS) network), a television network, and/or a combination of these or other types of networks.

Network 250 may include one or more wired and/or wireless networks. For example, network 250 may include a cellular network, the PLMN, a 2G network, a 3G network, a 4G network (e.g., an LTE network), a 5G network, and/or another network. Additionally, or alternatively, network 250 may include a WAN, a MAN, a telephone network (e.g., the Public Switched Telephone Network (PSTN)), an ad hoc network, an intranet, the Internet, a fiber optic-based network, and/or a combination of these or other types of networks.

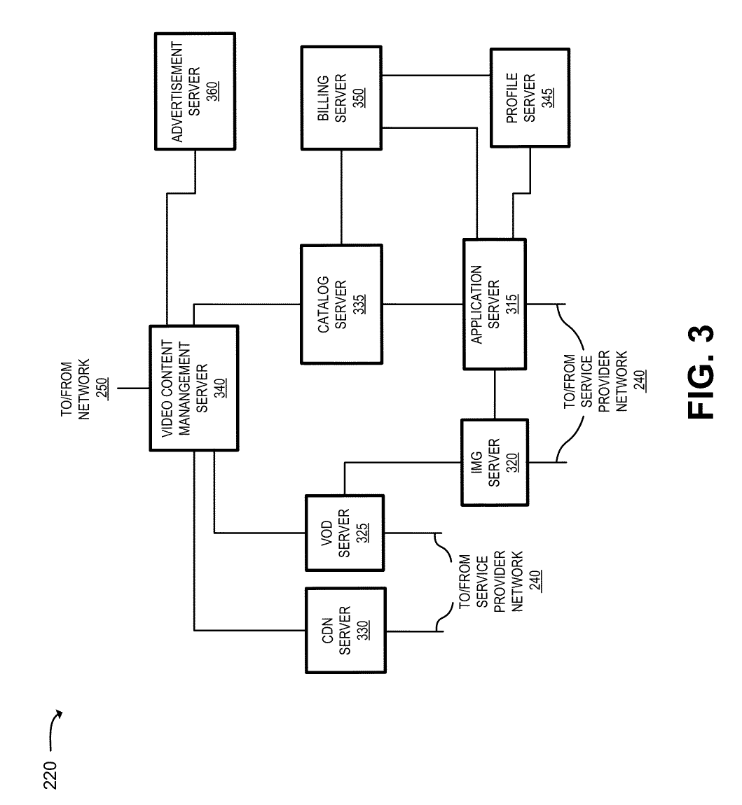

FIG. 3 is a diagram of example devices associated with VPS 220. VPS 220 may include an application server 315, an interactive media guide (IMG) server 320, a video on-demand (VOD) server 325, a content delivery network (CDN) server 330, a catalog server 335, a video content management (VCM) server 340, a profile server 345, a billing server 350, and an advertisement server 360. Although FIG. 3 shows example devices of VPS 220, in other implementations, VPS 220 may include fewer devices, additional devices, different devices, or differently arranged devices than depicted in FIG. 3. Additionally, or alternatively, one or more devices of VPS 220 may perform one or more tasks described as being performed by one or more other devices of VPS 220.

In the description below, VOD server 325 is described as provisioning video services for a type of user device 210 (e.g., a set top box) and CDN server 330 is described as provisioning video services for another other type of user device 210 (e.g., a computer device, a wireless mobile device, etc.) for explanatory purposes. In another implementation, the video services may be provisioned for the set top box and/or the other types of user devices in a number of ways. For example, VOD server 325 and/or CDN server 330 may be combined into a single device that provisions the video services for each type of user device 210. In another example, the video services may be provisioned, for each type of user device 210, by another device and/or network instead of, or in combination with, VOD server 325 and/or CDN server 330. Additionally, IMG server 320 is described as providing an a store front portal (i.e., via an IMG), that can be accessed by the set top box, and application server 315 is described as providing another store front portal (e.g., via a web page, a user interface, an interactive program guide, etc.), that can be accessed by the other types of user devices, for explanatory purposes. In another implementation, the store front portal may be provisioned for the set top box and/or the other types of user devices in a number of ways. For example, IMG server 320 and/or application server 315 may be combined into a single device that provisions the store front portal for each type of user device 210. In another example, the store front portal may be provisioned, for each type of user device 210, by another device and/or network instead of, or in combination with, IMG server 320 and/or application server 315. Thus, the examples below are provided for explanatory purposes only.

Application server 315 may include one or more server devices, or other types of computation or communication devices, that gather, process, search, store, and/or provide information in a manner similar to that described herein. Application server 315 may receive metadata that has been published by catalog server 335. The metadata may be associated with video assets that are to be made available and/or offered (e.g., for sale, rent, subscription, etc.) to user devices 210. Application server 315 may host a portal (e.g., a VPS store front), such as a private website (e.g., for subscribing user devices 210), a public website (e.g., for non-subscribing user devices 210), a user interface (UI) (e.g., that is accessible by wireless mobile handset-type user devices 210, etc.), an interactive program guide (e.g., an IMG for set top box-type user devices 210) and/or other types of user interfaces. The portal may enable single sign-on (SSO) portal access, to a user of one or more user devices 210, based on the same login credentials (e.g., username, password, personal identification number (PIN), etc.). Application server 315 may publish all or a portion of the metadata to the portal that permits any of user devices 210 to browse, perform searches, process payment, etc. for video assets based on the metadata that is published to the portal.

Application server 315 may perform a session management operation that authenticates user device 210 when user device 210 attempts to access the store front portal. Application server 315 may retrieve, from profile server 345, information relating to a profile associated with a user of one or more user devices 210. Application server 315 may obtain, from the information associated with the profile, information associated with a type of user device 210, a video format (e.g., screen size, bit rate, frame size, a frame reset rate, etc.) supported by user device 210, parental controls specified by the user, a transaction history associated with the user, a bookmark associated with a video asset, etc.

Application server 315 may permit user device 210 to browse and/or search video assets provided by VPS 220. Application server 315 may permit user device 210 to preview a trailer associated with a video asset and/or to select a video asset via the portal. Application server 315 may store information associated with the selected video asset in a logical shopping cart and/or electronic invoice. Application server 315 may recommend other video assets based on information associated with the transaction history and/or the parental controls. Application server 315 may perform an electronic transaction that permits user device 210 to purchase, rent, etc. a selected video asset (e.g., that was stored in the logical shopping cart), purchase a subscription for one or more video assets, bundles, etc. Application server 315 may, in one example, process payment information obtained from the information associated with the profile. Application server 315 may, in another example, send a notification, to billing server 350, that includes information associated with the transaction and which enables billing server 350 to include a cost of the transaction in an account associated with user device 210.

Application server 315 may send a notification to catalog server 335 that identifies the selected video content. The notification may include an indication of the type of user device 210 and/or information associated with the video format that user device 210 supports. Application server 315 may send an indication, to profile server 345, that the transaction associated with the selected video content was executed. The indication may enable other user devices 210, associated with the user, to obtain a copy of the selected video (e.g., in a video format supported by the other user devices 210) content at no additional cost to the user.

IMG server 320 may include one or more server devices, or other types of computation or communication devices, that gather, process, search, store, and/or provide information in a manner similar to that described herein. IMG server 320 may, for example, process metadata, that has been published by catalog server 335 and/or VOD server 325, in a manner similar to that described above (e.g., with respect to application server 315). The metadata may be associated with video content that may be obtained by a particular type of user device 210, such as a set top box user device 210.

IMG server 320 may publish all or a portion of the metadata to an IMG user interface (UI) that the set top box user device 210, associated with the user, may render for display on a video display device. IMG server 320 may permit the set top box user device 210 to access information associated with video assets, stored by VOD server 325, and access the actual video assets. IMG server 320 may, in another example implementation, communicate with application server 315, which may permit the set top box user device 210 to access the metadata associated video assets that are stored in CDN server 330.

IMG server 320 may receive a selection of a video asset (e.g., via the IMG) and may communicate with application server 315 in order to perform a session management operation, an electronic transaction, and/or a billing operation in a manner similar to that described above. IMG server 320 may communicate with VOD server 325 that causes the selected video asset to be transmitted (e.g., as a video stream) to the set top box user device 210. IMG server 320 may send an indication, to profile server 345, that the transaction associated with the selected video content was executed. The indication may enable other user devices 210, associated with the user, to obtain a copy of the selected video asset (e.g., in a video format supported by the other user devices 210) at, for example, no additional cost to the user.

VOD server 325 may include one or more server devices, or other types of computation or communication devices, that gather, process, search, store, and/or provide information in a manner similar to that described herein. VOD server 325 may, for example, perform operations to receive, store, process, and/or distribute video content in a format that is supported by set top box user devices 210.

VOD server 325 may receive published video assets and/or metadata from VCM server 340. VOD server 325 may store the published video assets in a memory associated with VOD server 325. VOD server 325 may manage a catalog that includes metadata associated with video assets received from VCM server 340. VOD server 325 may publish a portion of the metadata, associated with video assets (e.g., that are available for release and/or not subject to a blackout, etc.), to IMG server 320 that enables the catalog to be accessed, via the IMG, by set top box user devices 210.

VOD server 325 may respond to requests for selected video assets. VOD server 325 may receive, from IMG 320, an indication that a set top box user device 210 has selected a video asset via the IMG. VOD server 325 may, in response to the indication, forward information associated with the selected video asset, such as, for example, an identifier associated with the selected video asset (e.g., a title asset identifier (PAID)), information associated with content provider 230 (e.g., a provider identifier (PID)) from which the selected video asset was obtained, etc., to the set top box user device 210 via IMG server 320. VOD server 325 may receive, from the set top box user device 210, a request for the selected video asset and may transmit (e.g., via streaming video) the selected video asset to the set top box user device 210. The request may include the information associated with the selected video asset, the information associated with content provider 230, etc. The selected video asset may be encrypted (e.g., based on CAS-based encryption techniques) as the VOD server 325 is streaming the selected video asset to the set top box. The selected asset may be transmitted to the set top box in a manner that conforms to a particular QoS.

CDN server 330 may include one or more server devices, or other types of computation or communication devices, that gather, process, search, store, and/or provide information in a manner similar to that described herein. CDN server 330 may, for example, perform operations to receive, store, process, and/or distribute video content in a format that is supported by one or more types of user devices 210 (e.g., a computer device, a wireless mobile device, a gaming device, etc.) other than, or in addition to, a set top box user device 210. CDN server 330 may actually represent a content delivery network that includes multiple routing and/or storage devices.

CDN server 330 may receive published video assets in multiple video formats from VCM server 340. CDN server 330 may store the published video assets in a memory associated with CDN server 330. CDN server 330 may identify a respective storage location and/or URL for each format of each video asset that are stored within the memory and may send information associated with the storage locations and/or the URLs to catalog server 335.

CDN server 330 may respond to requests for selected video assets. CDN server 330 may receive, from user device 210, a request for a video asset based on a URL associated with the request. CDN server 330 may retrieve the video asset that is based on a particular video format that corresponds to the URL and may transmit the retrieved video asset to user device 210. CDN server 330 may transmit the video asset, that has been pre-encrypted by VCM server 340 (e.g., based on DRM-based encryption techniques), to user device 210. The selected asset may be transmitted (e.g., based on a progressive download protocol, adaptive bit rate streaming protocol, and/or some other protocol) to user device 210 in a manner that conforms to another QoS (e.g., best efforts).

Catalog server 335 may include one or more server devices, or other types of computation or communication devices, that gather, process, search, store, and/or provide information in a manner similar to that described herein. Catalog server 335 may, for example, receive, from VCM server 340, published metadata associated with video content that has been published to VOD server 325 and/or CDN server 330. Catalog server 335 may process and/or package the metadata in order to merchandize the video content to which the metadata corresponds.

Catalog server 335 may, for example, obtain metadata for a video asset that includes, for the video asset, an identifier (e.g., a title, etc.), a description, a genre, casting information (e.g., actors, directors, producer, etc.), ratings, reviews, etc. Catalog server 335 may merchandize the video asset by associating one or more prices to the metadata for the video asset. The prices may include a rental price (e.g., a price per single viewing, a price per day, per week, etc.), a sale price, a subscription price, etc. Catalog server 335 may associate the metadata, for the video asset, with other metadata, for other video assets, to create a service bundle (e.g., that includes the video asset and one or more other video assets and/or services) and may associate another price for the sale, rental, subscription, etc. of the service bundle. Catalog server 335 may identify a price to cover costs associated with the video asset (e.g., a settlement cost to be paid to content provider 230 who provided the video asset, costs associated with service provider network 240, expected profit, etc.).

Catalog server 335 may identify, from the metadata, information associated with the availability of the video asset based on a date on which the video asset is released, blacked out, etc. Catalog server 335 may publish the metadata, associated with the merchandized video assets, to the store front portal associated with VPS application 315. Catalog server 335 may not publish metadata associated with video assets that are identified as not yet being available. Catalog server 335 may publish other metadata associated with service bundles, promotions, recommendations, etc. to the store front portal.

Catalog server 335 may associate information associated with DRM with the metadata associated with the merchandized assets. For example, catalog server 335 may associate information associated with a license and/or a key (e.g., a private key, a public key, a CODEC, etc.) with the metadata for the merchandized video asset and may store the information associated with the license and/or the key in a memory associated with catalog server 335. The key may enable the video asset to be decrypted (e.g., by user device 210) when the information associated with the license indicates that the video asset can be decrypted and/or is otherwise available. Catalog server 335 may store the metadata for the video asset in the memory. Catalog server 335 may include, with the metadata, a URL associated with a location at which the video asset is stored within CDN server 330.

VCM server 340 may include one or more server devices, or other types of computation or communication devices, that gather, process, search, store, and/or provide information in a manner similar to that described herein. VCM server 340 may, for example, communicate with content providers 230 to ingest video content to be processed by VPS 220. VCM server 340 may ingest high quality video content (e.g., associated with a resolution level and/or bit rate that is greater than a threshold). The video content may include one or more video assets, metadata associated with the video assets, and/or information associated with DRM that corresponds to the video assets.

VCM server 340 may process the high quality video content using one or more video profiles, in order to generate one or more copies of the video content. The video profiles may identify a type of user device 210 for which the video asset is intended (e.g., a set top box, a computer device, a wireless handheld device, a gaming device, etc.), type of format supported by user device 210 (e.g., a bit rate, a resolution level, a frame refresh rate, a CODEC, etc.), an encryption technique, etc. The copies may correspond to one or more formats that are supported by one or more types of user devices 210. VCM server 340 may, for example, use a video profile to generate a video format associated with a frame rate, a resolution level, a screen size, a frame refresh rate, a bit rate, etc. that enables user device 210 (such as, for example, a smart phone) to receive, process, display, and/or store the video asset. In another example, VCM 340 may use another video profile to generate another video format associated with another frame rate, another resolution level, a different screen size, another frame refresh rate, another bit rate, etc. that enables another user device 210 (e.g., a computer device) to receive, process, display, and/or store the video asset.

VCM server 340 may perform a quality control operation (e.g., by reducing periods of black screen, within the video assets, that are greater than a threshold, etc.) on the formatted video assets to ensure that the formatted video asset can be transmitted to and/or played on user device 210 at a QoS that is greater than a threshold. VCM server 340 may encrypt the one or more formats and/or may publish the one or more formats, associated with the processed video assets, to VOD server 325 and/or CDN server 330.

VCM server 340 may process the metadata associated with the video assets to ensure that the metadata is supported by different types of user devices 210. For example, VCM server 340 may adapt image sizes (e.g., associated with cover art of a video asset, etc.) to one or more sizes that can be supported by the different types of user devices 210. VCM server 340 may publish the processed metadata and/or the information associated with the DRM to catalog server 335.

Profile server 345 may include one or more server devices, or other types of computation or communication devices, that gather, process, search, store, and/or provide information in a manner similar to that described herein. Profile server 345 may, for example, store information associated with a profile that includes information regarding the user and each user device 210 with which the user has registered with VPS 220. For example, information associated with the profile may further include information associated with the user (e.g., a username, password, PIN, etc.), information associated with each user device 210, such as a respective identifier (e.g., a mobile directory number (MDN), an Internet protocol (IP) address, a media access control (MAC) address, a CODEC identifier, etc.), and/or information associated with a type of user device 210, such as a computer device (e.g., a lap top computer, a tablet computer, etc.), a wireless mobile device (e.g., a Droid®, a Blackberry®, an iPhone®, etc.), a set top box, a gaming device, etc.

The information associated with the profile may also include a respective user history (e.g., prior purchases, prior URLs accessed, prior downloads, etc.) associated with each user device 210; information associated with services for which user device 210 has subscribed; information associated with a location (e.g., an address, a zip code, a city, etc.) of the user and/or user device 210; information associated user account limits, restrictions, etc.; information associated with a language spoken by the user; etc.

The information associated with the profile may include a bookmark that identifies a location at which user device 210 stopped a video asset. The bookmark may permit another user device 210, associated with the user, to resume playing the video asset (e.g., that has been downloaded on the other user device 210) at the location at which the video asset was stopped by user device 210.

Billing server 350 may include one or more server devices, or other types of computation or communication devices, that gather, process, search, store, and/or provide information in a manner similar to that described herein. Billing server 350 may, for example, perform billing operations associated with accounts that correspond to each user device 210 associated with a user. For example, billing server 350 may receive an indication that user device 210 (e.g., a computer device), associated with the user, downloaded a video asset (e.g., via a broadband service associated with service provider network 240) as a result of a transaction via the store front portal. Billing server 350 may generate billing information that identifies the video asset, the type of transaction (e.g., a purchase, rental, subscription, etc.), a price associated with the transaction, a time at which the transaction occurred, etc. Billing server 350 may associate the billing information with an account that corresponds to the user and/or user device 210. Billing server 350 may generate other billing information regarding another transaction with another user device 210 (e.g., a set top box) with which the user is associated. Billing server 350 may associate the other billing information with another account that corresponds to the user and/or the other user device 210. In yet another example, billing server 350 may process payment information (e.g., based on credit card information, debit card information, etc.) associated with a transaction with a further user device 210 to purchase, rent, subscribe to, etc. another video asset.

Advertisement server 360 may include a single server device or a collection of multiple server devices and/or computer systems. In one implementation, advertisement server 360 may store, or have access to, advertisements for various items (e.g., movies) and/or services. Furthermore, advertisement server 360 may store, or have access to, information associated with a user of two or more user devices 210. For example, the information may indicate a relationship of the user with user device 210-1 and/or user device 210-2. Advertisement server 360 may provide an advertisement to user device 210-2 based on the relationship. The information may further include profile information associated with the user, user device 210-1, and/or user device 210-2. Advertisement server 360 may use the profile information to select, and/or customize, advertisements that are provided by advertisement server 360 to user device 210-1 and/or user device 210-2.

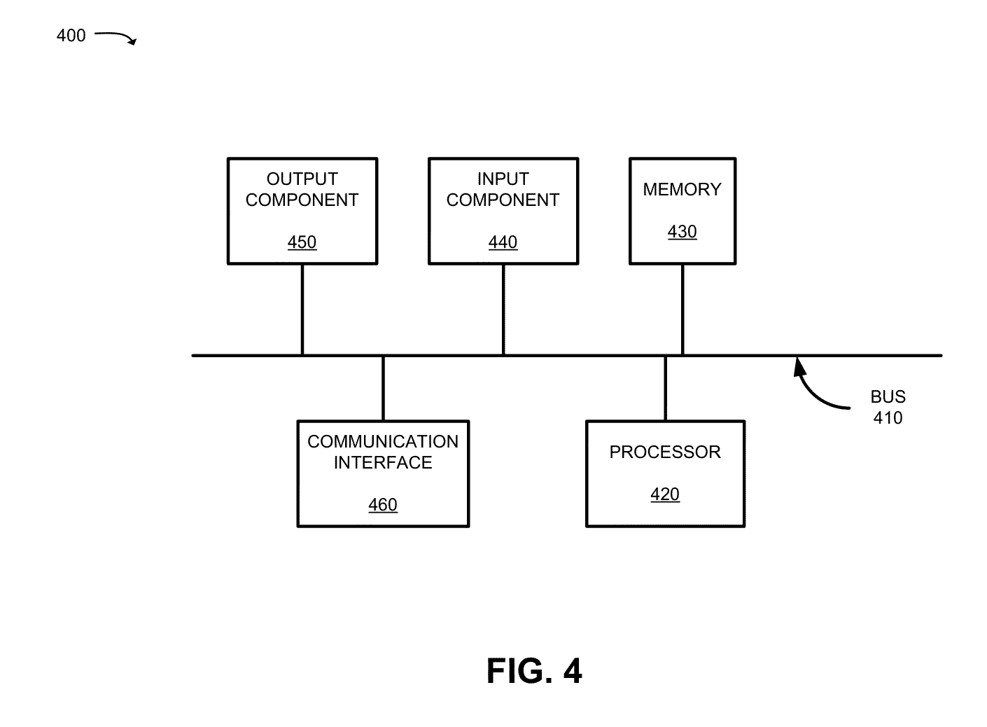

FIG. 4 is a diagram of example components of a device 400 that may correspond to user device 210, content provider 230, application server 315, IMG server 320, VOD server 325, CDN server 330, catalog server 335, VCM server 340, profile server 345, billing server 350 and/or advertisement server 360. Alternatively, each of user device 210, content provider 230, application server 315, IMG server 320, VOD server 325, CDN server 330, catalog server 335, VCM server 340, profile server 345, billing server 350 and/or advertisement server 360 may include one or more devices 400. Device 400 may include a bus 410, a processor 420, a memory 430, an input component 440, an output component 450, and a communication interface 460. Although FIG. 4 shows example components of device 400, in other implementations, device 400 may contain fewer components, additional components, different components, or differently arranged components than depicted in FIG. 4. For example, device 400 may include one or more switch fabrics instead of, or in addition to, bus 410. Additionally, or alternatively, one or more components of device 400 may perform one or more tasks described as being performed by one or more other components of device 400.

Bus 410 may include a path that permits communication among the components of device 400. Processor 420 may include a processor, microprocessor, or processing logic that may interpret and execute instructions. Memory 430 may include any type of dynamic storage device that may store information and instructions, for execution by processor 420, and/or any type of non-volatile storage device that may store information for use by processor 420.

Input component 440 may include a mechanism that permits a user to input information to device 400, such as a keyboard, a keypad, a button, a switch, etc. Output component 450 may include a mechanism that outputs information to the user, such as a display, a speaker, one or more light emitting diodes (LEDs), etc. Communication interface 460 may include any transceiver-like mechanism that enables device 400 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. For example, communication interface 460 may include mechanisms for communicating with another device or system via a network, such as service provider network 240 and/or network 250. In one alternative implementation, communication interface 460 may be a logical component that includes input and output ports, input and output systems, and/or other input and output components that facilitate the transmission of data to other devices.

As will be described in detail below, device 400 may perform certain operations relating to video content provisioning. Device 400 may perform these operations in response to processor 420 executing software instructions (e.g., computer program(s)) contained in a computer-readable medium, such as memory 430 or a secondary storage device (e.g., hard disk, CD-ROM, etc.). A computer-readable medium may be defined as a non-transitory memory device. A memory device may include space within a single physical memory device or spread across multiple physical memory devices. The software instructions may be read into memory 430 from another computer-readable medium or from another device. The software instructions contained in memory 430 may cause processor 420 to perform processes described herein. Alternatively, hardwired circuitry may be used in place of or in combination with software instructions to implement processes described herein. Thus, implementations described herein are not limited to any specific combination of hardware circuitry and software.

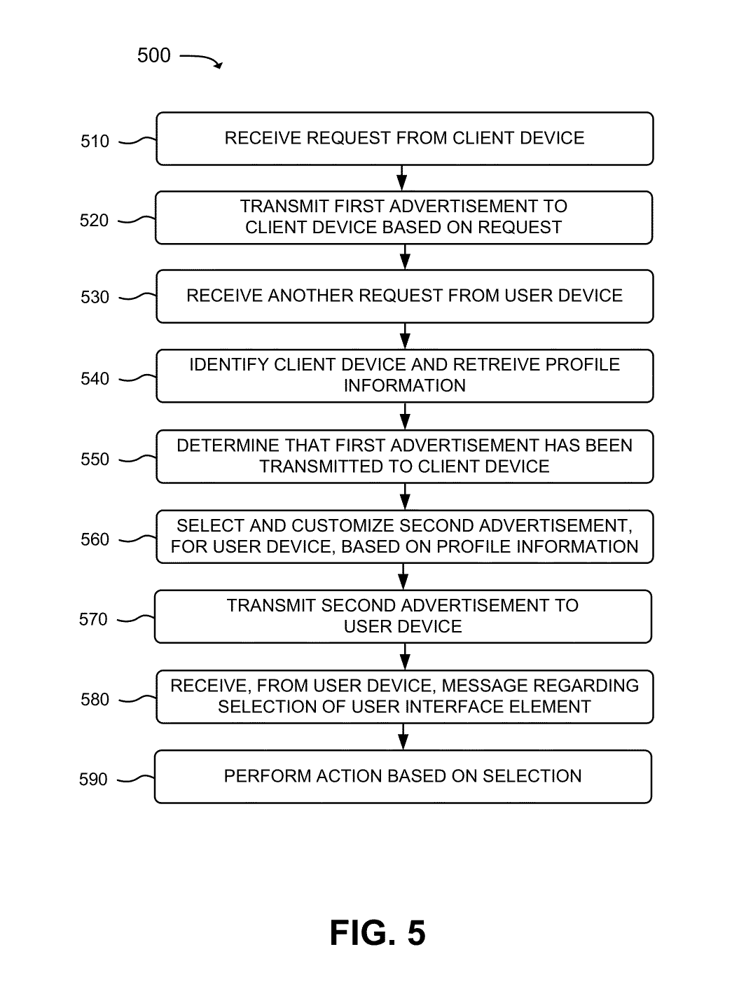

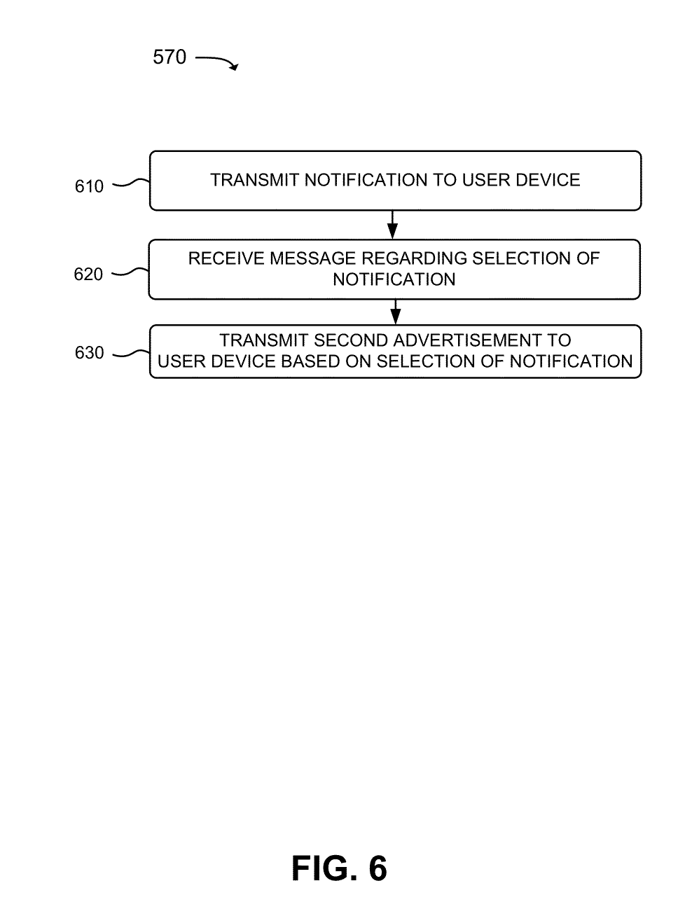

FIGS. 5-7 are flow charts of an example process 500 for providing advertisements via multiple devices. In one implementation, process 500 may be performed by advertisement server 360. In another implementation, some or all of process 500 may be performed by a device or collection of devices separate from, or in combination with, advertisement server 360.

As shown in FIG. 5, process 500 may include receiving a request from a client device (block 510) and transmitting a first advertisement to the client device based on the request (block 520). For example, assume that a user uses a remote control, associated with user device 210-1, to select to view particular content. Before displaying the particular content on a screen of user device 210-1, user device 210-1 may transmit a request for an advertisement to advertisement server 360. The request may include a client device identifier associated with user device 210-1 and a content identifier associated with the particular content. Advertisement server 360 may receive the request from user device 210-1, and may select a first advertisement based on the request. Advertisement server 360 may transmit the first advertisement to user device 210-1, and may update an indicator to indicate that the first advertisement has been transmitted to user device 210-1. User device 210-1 may display the first advertisement on a screen of user device 210-1.

Process 500 may further include receiving another request from a user device (block 530). For example, user device 210-2 may transmit a request to advertisement server 360, and advertisement server 360 may receive the request. The request may include a user device identifier associated with user device 210-2, a user identifier associated with the user, and/or a type of user device 210-2.

Process 500 may also include identifying the client device and retrieving profile information (block 540). For example, based on the user device identifier and/or the user identifier, advertisement server 360 may identify that the user of user device 210-2 is also the user of user device 210-1 that is associated with the client device identifier. Advertisement server 360 may further retrieve profile information associated with the user, based on the client device identifier, the user device identifier, and/or the user identifier.

The profile information may include, for example, personal information associated with the user, service information associated with types of multimedia services provided to the user via user device 210-1, and/or information associated with capabilities of user device 210-2. The personal information may include, for example, a geographic location associated with the user (e.g., a city and/or a state where user device 210-1 is located), type(s) of advertisements preferred by the user, types of content preferred by the user, types of multimedia services preferred by the user, etc. The service information may specify, for example, types of multimedia services, such as VOD services, DVR services, etc., that are provided to the user via user device 210-1. The capabilities information may include information that specifies types of advertisements that can be displayed by user device 210-2, including, for example, the type of user device 210-2, a size of a screen of user device 210-2, whether the screen is a touch screen, graphics capabilities of user device 210-2, an amount of bandwidth supported by user device 210-2, etc.

Process 500 may also include determining that the first advertisement has been transmitted to the client device (block 550). For example, after identifying that user device 210-1 is associated with the user, advertisement server 360 may determine whether the first advertisement has been transmitted to user device 210-1. Advertisement server 360 may determine that the first advertisement has been transmitted to user device 210-1 based on an updated indicator that indicates that the first advertisement has been transmitted to user device 210-1 of the user. If advertisement server 360 does not determine that the first advertisement has been transmitted to user device 210-1, advertisement server 360 may end process 500.

Process 500 may also include selecting and customizing a second advertisement, for the user device, based on the profile information (block 560). In one implementation, when advertisement server 360 determines that the first advertisement has been transmitted to user device 210-1, advertisement server 360 may select and customize a second advertisement, for user device 210-2, based on the profile information. In one example, the second advertisement may advertise the same item, service, and/or promotion as the first advertisement. Alternatively, or additionally, the second advertisement may advertise a different item, service, and/or promotion than the first advertisement.

In one example, the second advertisement may be a version of the first advertisement for user devices of the type of user device 210-2. Alternatively, or additionally, the second advertisement may include additional information, such as a video trailer for a movie, that is not included in the first advertisement. The second advertisement may include the additional information when the personal information indicates that the user prefers advertisements with videos and/or the capabilities information indicates that user device 210-2 supports advertisements with videos.

Alternatively, or additionally, the second advertisement may include user interface elements that allow the user to initiate transaction(s) associated with the same item, service, and/or promotion that is also advertised by the first advertisement. For example, when the services information specifies that the user receives VOD service via user device 210-1, the second advertisement may include a mechanism to purchase/rent the movie via the VOD service. Herein, a button may refer to any other type of mechanism, such a link, a menu item, etc. that can be used to perform an action.

Alternatively, or additionally, the second advertisement may include an additional advertisement, which is not included in the first advertisement. Advertisement server 360 may select the additional advertisement based on the personal information of the user. The additional advertisement may include, for example, a promotion to purchase tickets for a movie screening at a movie theater located within the geographic location associated with the user.

Process 500 may also include transmitting the second advertisement to the user device (block 570). In one example implementation, advertisement server 360 may transmit the second advertisement user device 210-2, and user device 210-2 may display the second advertisement on the screen of user device 210-2. Alternatively, or additionally, advertisement server 360 may determine a delay period (e.g., a particular number of seconds, minutes, etc.) based on the type of user device 210-2 and/or a type of user device 210-1. In one example, the delay period may equal a period of time that is between 0 seconds and a maximum delay period, which is a constant (e.g., 5 seconds), in length. Advertisement server 360 may measure the delay period from a time when the first advertisement is transmitted to user device 210-1. Advertisement server 360 may transmit the second advertisement to user device 210-2 at an end of the delay period.

In one example implementation, process block 570 may include the process blocks depicted in FIG. 5. As shown in FIG. 5, process block 570 may include transmitting a notification to the user device (block 610), receiving a message regarding a selection of the notification (block 620), and transmitting the second advertisement to the user device based on the selection of the notification (block 630). For example, the personal information of the user may include a preference that indicates that the user prefers for user device 210-2 to receive notifications, regarding advertisements, instead of the advertisements (e.g., in order to prevent a disruption of the user's activity on user device 210-2). Based on the preference, advertisement server 360 may generate a notification for the second advertisement, and may transmit the notification to user device 210-2. User device 210-2 may display the notification in a portion (e.g., top-left corner) of the screen of user device 210-2. The notification may indicate that the second advertisement is available to be viewed by the user via user device 210-2. The user may use user device 210-2 to select the notification, and user device 210-2 may transmit a message regarding the selection of the notification to advertisement server 360. Advertisement server 360 may receive the message regarding the selection of the notification, and may transmit the second advertisement to user device 210-2 in response to the selection of the notification.

Returning to FIG. 5, process 500 may also include receiving, from the user device, a message regarding a selection of a user interface element (block 580) and performing an action based on the selection (block 590). In one example implementation, as discussed above, the second advertisement may include a user interface element (e.g., a button) for initiating a financial transaction associated with an item/promotion advertised in the second advertisement. Assume that the user, via user device 210-2, selects the user interface element in order to perform the financial transaction. User device 210-2 may transmit a message regarding the selection of the user interface element to advertisement server 360. Based on the selection of the user interface element, advertisement server 360 may identify the financial transaction, and may retrieve a user interface required to complete the financial transaction. The user interface may include, for example, a form for purchasing the movie. Advertisement server 360 may transmit the user interface to user device 210-2, and user device 210-2 may display the user interface. The user may use the user interface to complete the financial transaction.

Alternatively, or additionally, the selection may include a request to receive additional information associated with an aspect of the item/promotion. The user may use user device 210-2 to select, for example, an option to receive additional information associated with a movie, such as a description of the movie, reviews for the movie, ratings by critics for the movie, etc. User device 210-2 may transmit a message regarding the selection of the option to receive the additional information to advertisement server 360. Based on the selection of the option, advertisement server 360 may retrieve the additional information, and may transmit the additional information to user device 210-2. User device 210-2 may display the additional information.

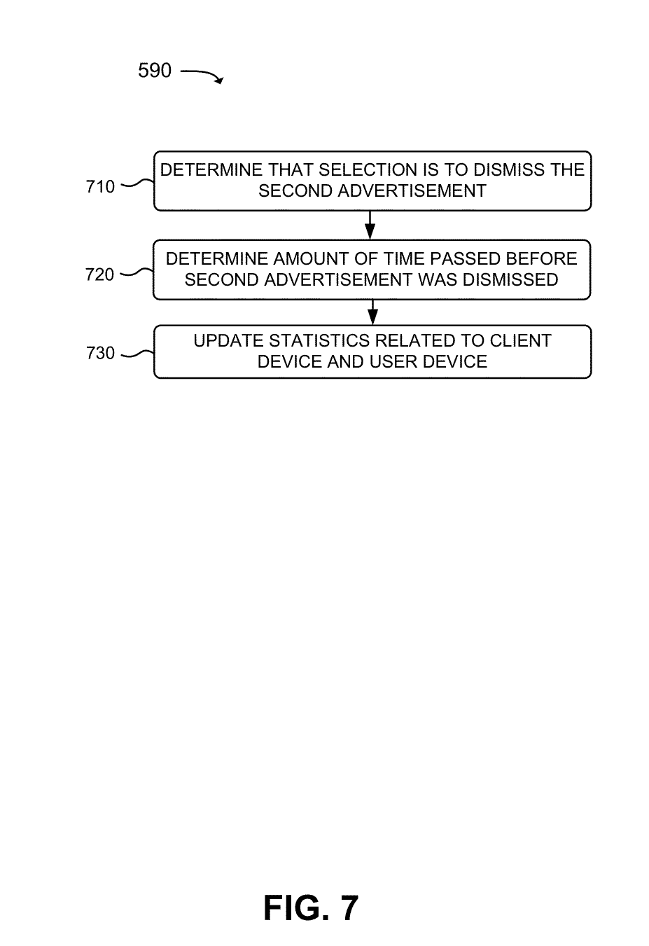

In one example implementation, process block 590 may include the process blocks depicted in FIG. 7. As shown in FIG. 7, process block 590 may include determining that the selection is to dismiss the second advertisement (block 710), determining an amount of time that passed before the second advertisement was dismissed (block 720), and updating statistics related to the client device and the user device (block 730). For example, assume that the user, via user device 210-2, selects to dismiss the second advertisement. In response to the selection to dismiss the second advertisement, user device 210-2 may remove the second advertisement from the screen of user device 210-2, and may transmit the selection to advertisement server 360. Based on the selection, advertisement server 360 may determine that the selection is to dismiss the second advertisement. When advertisement server 360 determines that the selection is to dismiss the second advertisement, advertisement server 360 may determine an amount of time that passed before the second advertisement was dismissed. The amount of time may equal, for example, a time period between when the second advertisement was transmitted to user device 210-2 and when the selection to dismiss the second advertisement was received from user device 210-2.

Advertisement server 360 may store or have access to statistics that specify average amounts of times that pass, for example, before various advertisements, such as the second advertisement, are dismissed. The average amounts of times may correspond to different types of user devices, including the type of user device 210-2; different types of client devices, including the type of user device 210-1; and/or different types of advertisements, including a type associated with the second advertisement. Advertisement server 360 may update one or more of the average amounts of times based on the amount of time that passed before the second advertisement was dismissed.

Advertisement server 360 may use the statistics to select and/or customize advertisements in the future, as described above with reference to block 560 of FIG. 5. Additionally, or alternatively, an operator of advertisement server 360 may use the statistics to identify types of user devices and/or types of client devices that are best for providing advertisements.

Alternatively, or additionally, advertisement server 360 may receive requests from two or more user devices 220, such as user device 210-2 (e.g., a mobile device) and user device 210-3 (e.g., tablet computer), of a user. Advertisement server 360 may provide an advertisement to each of the two or more user devices 220 after providing an original advertisement to user device 210-1. As a result, a screen of user device 210-1 and each screen of the two or more user devices 220 may display advertisements for a particular item, service, or promotion. Accordingly, the user may have an opportunity to view one or more of the advertisements on multiple screens, such as on the screen of user device 210-1, on a screen of the user device 210-2, and on a screen of user device 210-3.

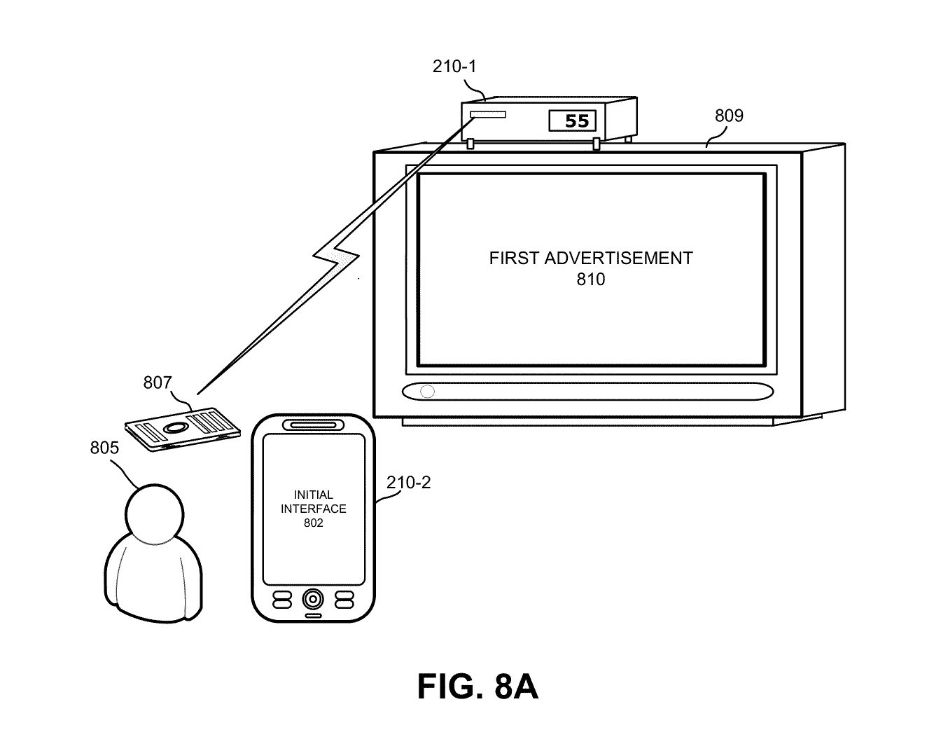

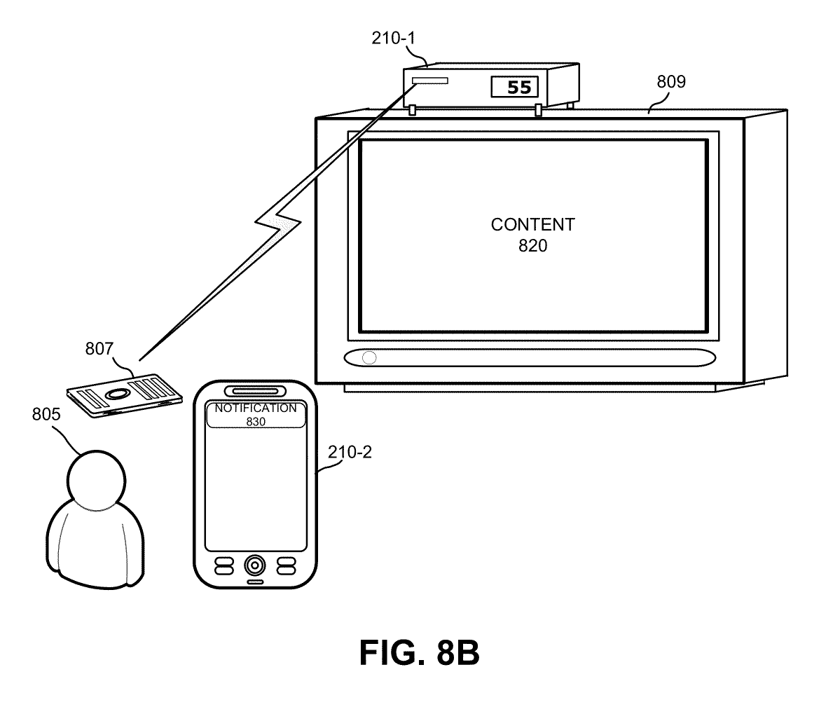

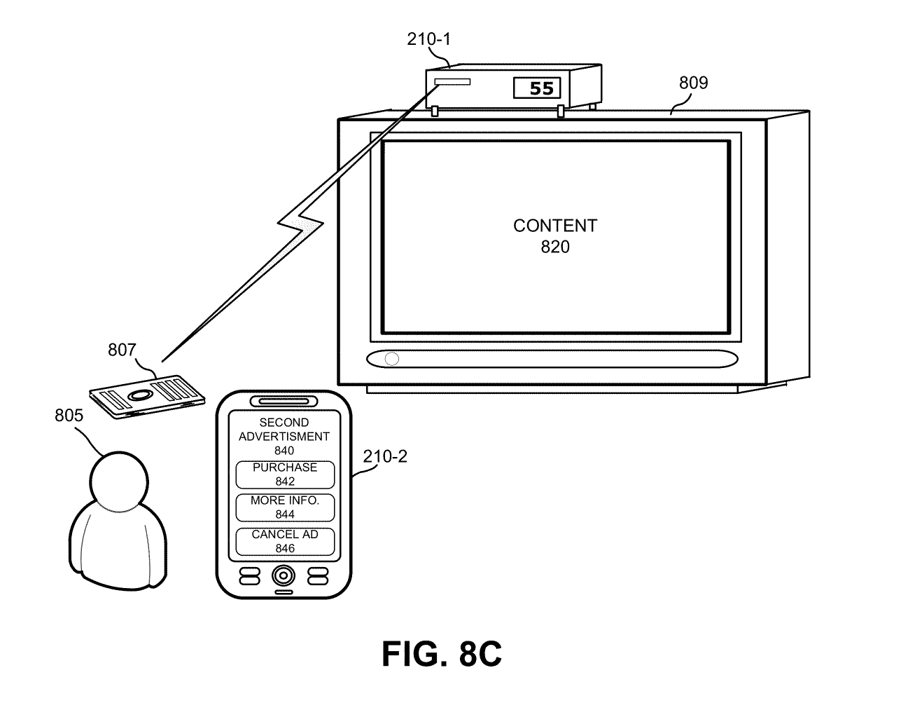

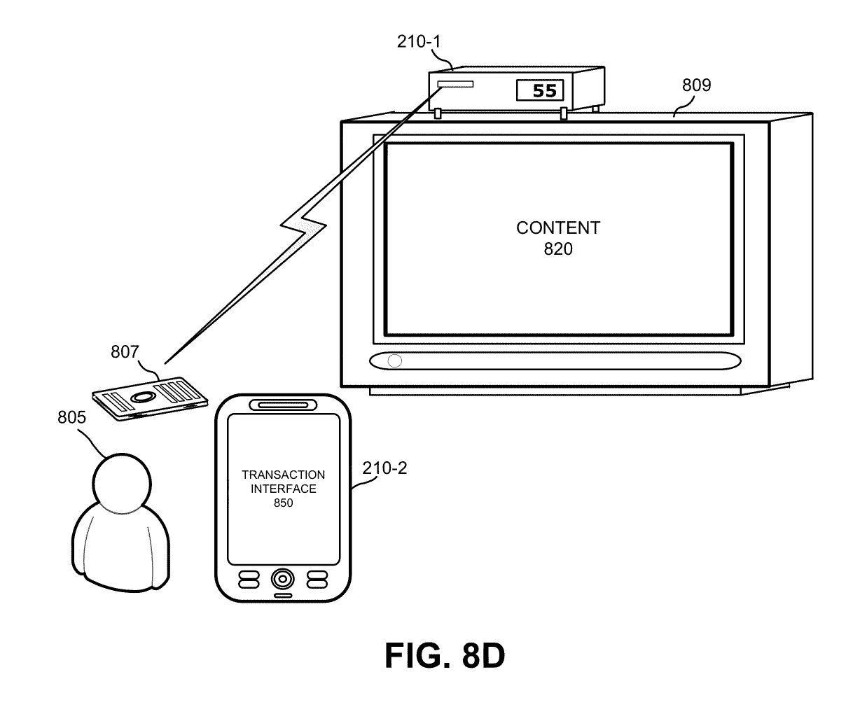

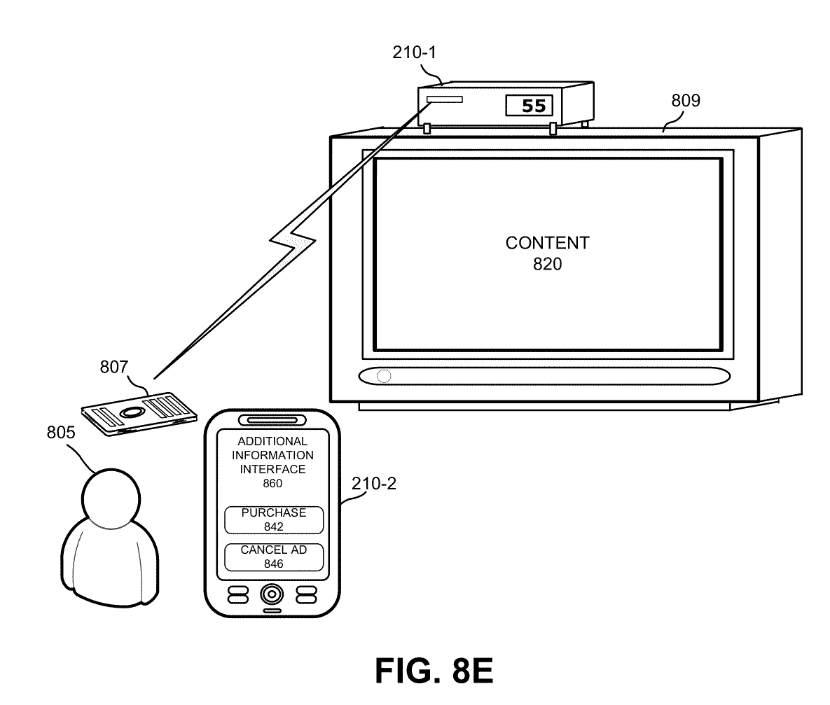

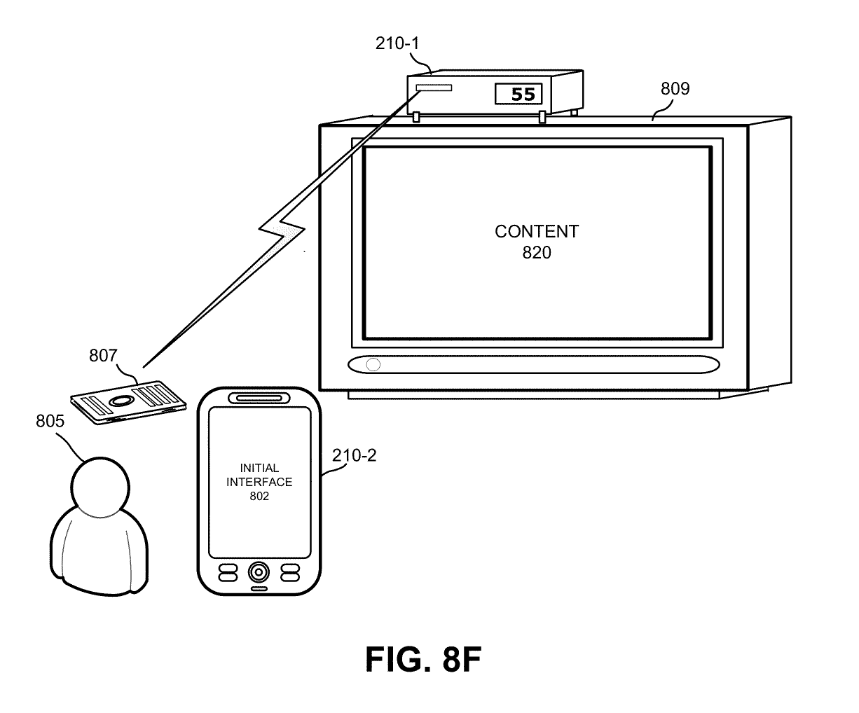

FIGS. 8A-8F are diagrams of an example advertisement information that may be provided to multiple user devices 220. As shown in FIG. 8A, user device 210-2, associated with a user 805 (FIG. 8A), may display an initial interface 802 on a screen of user device 210-2. Initial interface 802 may include, for example, an interface of a particular application of user device 210-2, such as a web browser, an email application, etc., or a home interface of an operating system of user device 210-2.

Assume that user 805 uses remote control 807 to turn on user device 210-1 of user 805. User device 210-1 may display a menu (not shown) on a screen 809, such as a television display, of user device 210-1. Further assume that user 805 uses remote control 807 to select content 820 (FIG. 8B) from the menu. Content 820 may include, for example, a television program or a movie. Before displaying content 820, user device 210-1 may transmit a request for a first advertisement 810 (FIG. 8A) to advertisement server 360. Advertisement server 360 may select and retrieve first advertisement 810 based on the request, and may transmit first advertisement 810 to user device 210-1. As further shown in FIG. 8A, user device 210-1 may display first advertisement 810 on screen 809 of user device 210-1.

Also assume that user 805 uses remote control 807 to select to dismiss first advertisement 810. As shown in FIG. 8B, when user 805 selects to dismiss first advertisement 810, user device 210-1 may remove first advertisement 810 from screen 809 of user device 210-1, and may begin playing content 820 on the screen of user device 210-1. Meanwhile, user device 210-2 may transmit a request to advertisement server 360. Advertisement server 360 may receive the request from user device 210-2, and may determine that first advertisement 810 has been transmitted to user device 210-1 of user 805, who is also associated with user device 210-2. Accordingly, advertisement server 360 may select a second advertisement 840 (FIG. 8C) for user device 210-2 based on first advertisement 810 and profile information associated with user 805, user device 210-1, and/or user device 210-2. First advertisement 810 and second advertisement 840 may include a promotion to purchase or rent the same item, such as a movie.

Advertisement server 360 may also generate a notification 830 (FIG. 8B) for second advertisement 840. Advertisement server 360 may transmit notification 830 and second advertisement 840 to user device 210-2. As further shown in FIG. 8B, user device 210-2 may display notification 830 in a portion of the screen of user device 210-2.

Assume that user 805 selects notification 830. As shown in FIG. 8C, in response to the selection of notification 830, user device 210-2 may display second advertisement 840 on the screen of user device 210-2. As further shown in FIG. 8C, second advertisement 840 may include, for example, a purchase button 842, a more information button 844, and a cancel advertisement button 846.

Assume that user 805 selects purchase button 842 in order to perform a transaction for purchasing the item advertised by second advertisement 840. User device 210-2 may transmit information regarding the selection of purchase button 842 to advertisement server 360. In response to receiving the information, advertisement server 360 may retrieve a transaction interface 850 (FIG. 8D) that is required to complete the transaction, and may transmit transaction interface 850 to user device 210-2. As shown in FIG. 8D, user device 210-2 may display transaction interface 850 on the screen of user device 210-2. Transaction interface 850 may include one or more forms for completing the transaction. User 805 may use transaction interface 850 in order to purchase the item.

Alternatively, or additionally, assume that user 805 selects more information button 844 in order to view additional information about the item advertised by second advertisement 840. User device 210-2 may transmit information regarding the selection of more information button 844 to advertisement server 360. In response to receiving the information, advertisement server 360 may retrieve the additional information about the item, may generate an additional information interface 860 (FIG. 8E) based on the additional information, and may transmit additional information interface 860 to user device 210-2. As shown in FIG. 8E, user device 210-2 may display additional information interface 860 on the screen of user device 210-2. Additional information interface 860 may include the additional information. As further show in FIG. 8E, additional information interface 860, like second advertisement 840, may include purchase button 842 and cancel advertisement button 846.

Additionally, or alternatively, assume that user 805 selects cancel advertisement button 846, of second advertisement 840 or additional information interface 860, in order to dismiss second advertisement 840. As shown in FIG. 8F, in response to the selection of cancel advertisement button 846, user device 210-2 may remove second advertisement 840 or additional information interface 860 from the screen of user device 210-2, and may, again, display initial interface 802 on the screen of user device 210-2. User device 210-2 may also, as described above with reference to FIG. 7, transmit information regarding the selection of cancel advertisement button 846 to advertisement server 360. If the user does not select cancel advertisement button 846 within a particular period of time (e.g., 30 seconds after displaying second advertisement 840), user device 210-2 may automatically remove second advertisement 840 or additional information interface 860 from the screen of user device 210-2, and may, again, display initial interface 802 on the screen of user device 210-2.

Systems and/or methods described herein may display an advertisement, for an item, on a screen of user device 210-2 after an original advertisement, for the item, is displayed by user device 210-1. As a result, a user of user device 210-2 and user device 210-1 may view at least one of the original advertisement or the advertisement.

The foregoing description provides illustration and description, but is not intended to be exhaustive or to limit the invention to the precise form disclosed. Modifications and variations are possible in light of the above teachings or may be acquired from practice of the invention.

While series of blocks have been described with regard to FIGS. 4-6 the order of the blocks may be modified in other implementations. Further, non-dependent blocks may be performed in parallel.

It will be apparent that systems and methods, as described above, may be implemented in many different forms of software, firmware, and hardware in the implementations illustrated in the figures. The actual software code or specialized control hardware used to implement these systems and methods is not limiting of the invention. Thus, the operation and behavior of the systems and methods were described without reference to the specific software code—it being understood that software and control hardware can be designed to implement the systems and methods based on the description herein.

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method comprising:
receiving, by a device, a first request from a client device of a user;
selecting, by the device, a first advertisement based on the first request;
transmitting, by the device, the first advertisement to the client device;
receiving, by the device, a second request from a user device of the user, the second request including an identifier associated with the user;
determining, by the device and based on the identifier, that the user of the user device is also the user of the client device;
determining, by the device, whether the server transmitted the first advertisement to the client device;
selecting, by the device, a second advertisement, for the user device, when the device transmitted the first advertisement to the client device; and
transmitting, by the device, the second advertisement to the user device,
the first advertisement and the second advertisement advertising a particular item.

2. The method of claim 1, further comprising:
receiving a message regarding a selection of a user interface element of the second advertisement; and
performing an action based on the message.

3. The method of claim 2,
where the user interface element includes a button for purchasing the particular item, and
where performing the action comprises:
retrieving, based on the message, a user interface for completing a transaction for purchasing the particular item, and
transmitting the user interface to the user device.

4. The method of claim 2,
where the user interface element comprises a mechanism for dismissing the second advertisement, and
where performing the action comprises:
determining, based on the message, an amount of time that passed before the selection of the user interface element, and
updating, based on the amount of time, a statistic associated with a type of the user device.

5. The method of claim 1, where transmitting the second advertisement to the user device comprises:
generating a notification for the second advertisement,
transmitting the notification to the user device,
receiving, from the user device, a message regarding a selection of the notification, and
transmitting, to the user device, the second advertisement in response to the message.

6. The method of claim 1, further comprising:
retrieving, based on the identifier, information associated with the user or the user device, and
customizing the second advertisement based on the information.

7. The method of claim 6, where the information includes at least one of:
a geographic location associated with the user,
a type of the user device, or
a type of service provided to the user via the client device.

8. The method of claim 1, where determining whether the server transmitted the first advertisement to the client device comprises:
updating an indicator, associated with the user, to indicate that the server transmitted the first advertisement to the client device, and
determining that the server transmitted the first advertisement to the client device based on the updated indicator.

9. The method of claim 1,
where the second advertisement includes information that is not included in the first advertisement, and
where the information comprises at least one of:
additional information about the particular item,
a video associated with the particular item,
a user interface element for initialing a transaction associated with the particular item, or
an additional advertisement that advertises a different item.

10. A device comprising:
a processor to:
transmit a first advertisement to a client device of a user;
update an indicator, associated with the user, to indicate that the server transmitted the first advertisement to the client device;
receive a request from a user device of the user, the request including an identifier associated with the user;
determine, based on the identifier, that the user of the user device is also the user of the client device;
determine, based on the identifier and the indicator, that the device transmitted the first advertisement to the client device;
select a second advertisement for the user device based on the request; and
transmit the second advertisement to the user device,
the first advertisement and the second advertisement advertising a particular item.

11. The device of claim 10, where the processor is further to:
receive a content request from the client device, the content request including a content identifier associated with content selected by the user; and
select the first advertisement based on the content identifier.

12. The device of claim 10, where, when selecting the second advertisement, the processor is to:
retrieve, based on the identifier, information associated with the user or the user device, and
select the second advertisement based on the information.

13. The device of claim 12, where the information includes at least one of:
a geographic location associated with the user,
a type of the user device,
information associated with a screen of the user device,
an amount of bandwidth supported by the user device, or
a type of service provided to the user via the client device.

14. The device of claim 10, where, when transmitting the second advertisement to the user device, the processor is to:
generate a notification for the second advertisement,
where the notification, when selected by the user, prompts a display of the second advertisement on a screen of the user device, and
transmit the notification and the second advertisement to the user device.

15. The device of claim 10, where the processor is further to:
receive, from the user device, a message regarding a selection of a user interface element of the second advertisement; and
perform an action, associated with the particular item or the second advertisement, based on the message.

16. A computer-readable medium, comprising:
one or more instructions that, when executed by one or more processors of a device, cause the one or more processors to:
transmit a first advertisement to a client device of a user;
receive a request from a user device of the user;
determine, based on the request, that the user of the user device is also the user of the client device;
determine whether the device transmitted the first advertisement to the client device;
determine a type of the user device based on the request;
select, based on the type of the user device, a second advertisement when the device transmitted the first advertisement to the client device; and
transmit the second advertisement to the user device,
the first advertisement and the second advertisement advertising a particular promotion, and
the first advertisement being different from the second advertisement;

17. The computer-readable medium of claim 16, further comprising:
one or more instructions that, when executed by the one or more processors of the device, cause the one or more processors to:
receive, from the user device, a message regarding a selection of a user interface element of the second advertisement,
where the first advertisement does not include the user interface element; and
perform an action, associated with the particular promotion or the second advertisement, based on the message.

18. The computer-readable medium of claim 16, further comprising:
one or more instructions that, when executed by the one or more processors of the server, cause the one or more processors to:
retrieve information associated with the user, and
customize the second advertisement based on the information.

19. The computer-readable medium of claim 16, where:
the client device is a set-top box, and
the user device is one of a mobile device, a tablet computer, or a desktop computer.

20. The computer-readable medium of claim 16, further comprising:
one or more instructions that, when executed by the one or more processors of the server, cause the one or more processors to:
receive a different request from a different user device of the user;
determine, based on the different request, that the user of the different user device is also the user of the client device;
select a third advertisement for the different user device based on the different request; and
transmit the third advertisement to the different user device,
where the third advertisement advertises the particular promotion.
